(19) United States
(12) Patent Application Publication
(10) Pub. No.: US 2017/0241468 A1
(43) Pub. Date: Aug. 24, 2017

(54) Lug Nut Covers

(71) Applicant: Brandon Wright, Tulare, CA (US)

(72) Inventor: Brandon Wright, Tulare, CA (US)

(21) Appl. No.: 15/438,654

(22) Filed: Feb. 21, 2017

Related U.S. Application Data
(60) Provisional application No. 62/297,996, filed on Feb. 22, 2016.

(51) Int. Cl. F16B 37/14

(52) U.S. Cl. CPC F16B 37/14

(57) ABSTRACT

The present invention provides metallic lug nut covers having an internal opening that may be sized to snugly fit over a lug nut of a vehicle wheel. Embodiments may include an optional internal threaded bore to engage the cover to the mounting bolt holding the lug nut. Embodiments may also include a groove and O-ring for sealed attachment.

Embodiments of the present invention may be provided in a generally round shape, but may also be of other shapes including without limitation, hexagonal, pentagonal, octagonal, triangular, square and other shapes.

This application claims the benefit of U.S. provisional patent application No. 62/297,996 filed on Feb. 22, 2016 which is incorporated herein by this reference in its entirety.

### BACKGROUND OF THE INVENTION

1. Field of the Invention

The present invention relates generally to wheel accessories for motor vehicles and, more particularly, to lug nut covers for improved attachment to wheel lug nuts in order to cover and protect the lug nuts, while providing increased durability and longevity for the lug nut covers themselves.

2. Description of the Prior Art

A lug nut or wheel nut is a fastener for securing a wheel to a motor vehicle, including automobiles, trucks and other large vehicles using wheels and/or rubber tires. Typically, a lug nut is a nut with an open, rounded or tapered end, which is attached to a threaded stud or bolt on the vehicle. Lug nuts are typically used with steel or aluminum wheels. A plurality of lug nuts are generally used to secure a wheel to threaded wheel studs and thereby to a vehicle's axles.

Generally, lug nut caps or covers are well known in the art. Lug nut covers are designed to cover the lug nut to prevent damage, such as corrosion and dirt of the wheel lug. A lug nut cover can further serve a decorative or ornamental purpose. Typically, lug nut covers known in the art are made of plastic and simply snap on to the lug nut. These snap on, plastic lug nut covers are not particularly durable and are susceptible to breaking and, thus, must be constantly replaced. Furthermore, the “snap on” feature does not provide a particularly efficient attachment means, so these covers constantly fall off the lug nut and, therefore, must be replaced for this reason as well.

Accordingly, there is a need for a more efficient lug nut cover. In particular, the lug nut cover should be more durable, so that it does not break easily. Furthermore, the lug nut cover should provide a more effective attachment means with the lug nut, so that it does not easily fall off.

The present invention provides lug nut covers which satisfy these requirements, while at the same time providing additional useful features.

### SUMMARY OF THE INVENTION

The present invention addresses the matters described above by providing lug nut covers made of metal having an internal opening that may be sized to snugly fit over a lug nut of a vehicle wheel, and/or which may include an optional internal threaded bore to engage the cover to the mounting stud or bolt holding the lug nut.

Embodiments of the covers of the present invention may be provided in a generally round shape, but may also be of other shapes including without limitation, hexagonal, pentagonal, octagonal, triangular, square and other shapes.

It is therefore an object of the present invention to provide durable metallic lug nut covers which may be securely engaged with or fastened to a lug nut and/or to the lug nut's mounting bolt.

It is also an object of the present invention to provide lug nut covers that resist rust, corrosion and other damage.

It is also an object of the present invention to provide lug nut covers that fit securely in order to avoid frequent replacement.

Additional objects of the invention will be apparent from the detailed descriptions and the claims herein.

### BRIEF DESCRIPTION OF THE DRAWINGS

The accompanying drawings incorporated in and forming a part of the specification, illustrate several aspects of this disclosure, and together with the description serve to explain the principles of the disclosure. In the drawings:

FIG. 1 is a perspective view of a representative plastic lug nut cover known in the prior art;

FIG. 2 is a perspective view of another representative plastic lug nut cover known in the prior art;

FIG. 3 is a perspective view of a first embodiment of the present invention having a hexagonal shape;

FIG. 4 is a cross-sectional view of the embodiment of FIG. 3;

FIG. 5 is a top view of the embodiment of FIG. 3;

FIG. 6 is a perspective view of a second embodiment of the present invention having a round shape;

FIG. 7 is a cross-sectional view of the embodiment of FIG. 6;

FIG. 8 is a top view of the embodiment of FIG. 6;

FIG. 9 is a perspective view of several of the embodiments of FIG. 3 installed on a vehicle wheel.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the invention is defined only by the appended claims and their equivalents. In accordance with the disclosure, a lug nut cover is hereinafter described.

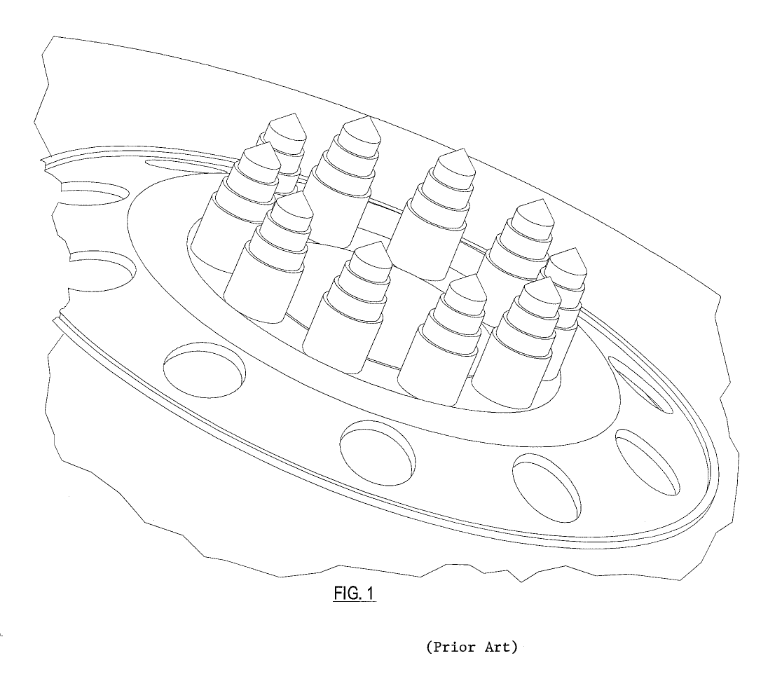

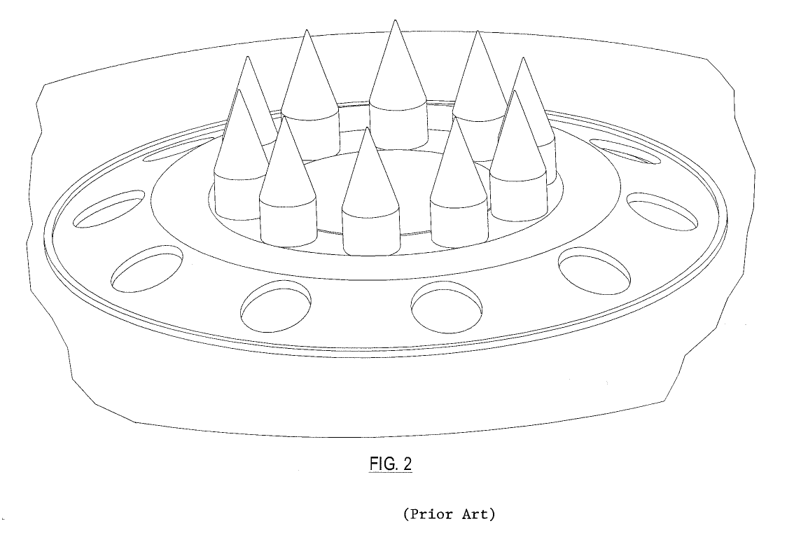

Referring first to the prior art shown in FIGS. 1 and 2, it is seen that traditional plastic lug nut covers are illustrated. These plastic lug nut covers simply snap over the lug nut on the wheel. Due to the snap on feature, these plastic lug nut are highly susceptible to falling off the lug nut during operation of the vehicle. Furthermore, due to their plastic nature, these lug nut covers are also susceptible to damage. As a result, traditional plastic lug nut covers must be constantly replaced, which is not only time-consuming, but expensive.

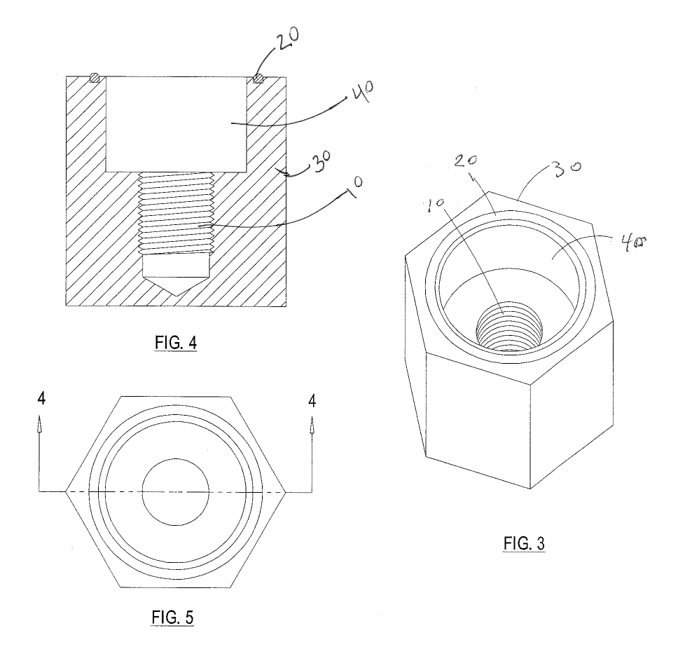

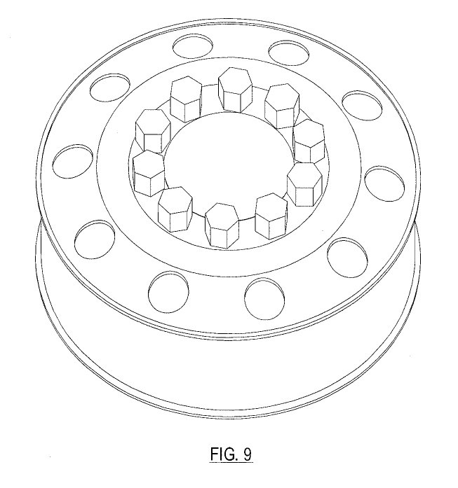

Referring to the exemplary embodiments of the invention disclosed in FIGS. 3-9, it is seen that two embodiments of a lug nut cover are illustrated (FIGS. 3-5, and FIGS. 6-8). The illustrated embodiments provide a number of advantages over traditional plastic lug nut covers. Specifically, the lug nut covers of the present invention are made of metal, preferably aluminum or steel, which is substantially more durable than plastic. As a result, the lug nut covers of the present invention provide better protection for lug nuts, and are also less susceptible to damage. The solid metal lug nut covers of the present invention provide enhanced durability for the covers and better protection for the lug nut.

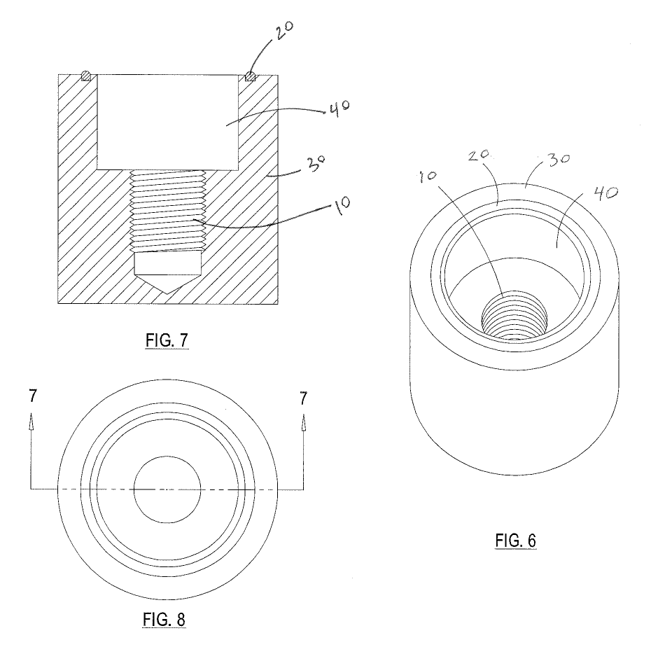

In the illustrated embodiments, the lug nut covers of the present invention have a solid metal body 30, which may be provided in different shapes. For example, FIGS. 3-5 show the body being a hexagonal shape, while FIGS. 6-8 show a round shape. It is to be appreciated that in other embodiments, the lug nut covers of the present invention may be provided in various alternative shapes including without limitation, oval, tear-drop, triangular (3 sides), square (4 sides), pentagonal (5 sides), octagonal (8 sides), and others (10 sides, 12 sides, etc.).

In the illustrated embodiments, at one end of the body 30, a circular opening 40 is provided. The circular opening 40 is designed to fit around the lug nut of a vehicle wheel. The internal diameter of opening 40 is preferably sized such that it fits tightly against a lug nut of a vehicle wheel in order to stay in place over the lug nut. It is to be appreciated that opening 40 may be provided in a variety of different sizes which correspond to different sizes of lug nuts, in order to provide secure engagement with them.

In alternative embodiments, such as those illustrated in FIGS. 3-8, a threaded internal bore 10 may be provided at one end of opening 40 such that bore 10 extends into the interior of the body. In these embodiments, the threaded bore 10 of the covers of the present invention may be threaded onto the outwardly extending bolt or stud onto which a vehicle lug nut has been engaged. This allows the cover of the present invention to be more securely engaged over the lug nut, by securing it to the same bolt as the lug nut itself. It is to be appreciated that bore 10 may be provided in a variety of different diameters and with different thread patterns in order to correspond to different sizes and thread patterns on lug nut bolts, in order to allow the covers of the present invention to engage with them.

In some embodiments, an optional groove may be provided either inside the circular opening, or adjacent to it (e.g. FIG. 4), in order to receive an optional rubberized O-ring 20. In these embodiments, O-ring 20 provides for additional security for a tighter fit and/or as a sealant.

Embodiments of the covers of the present invention may be polished and/or chrome-plated and may be designed to prevent rust and exhibit corrosion resistant properties.

Advantageously, the lug nut covers of the present invention provide significant advantages over traditional lug nut covers. Specifically, one of the primary purposes of the lug nut covers of the present invention is enhanced longevity as the metal body promotes durability. As a result, the lug nut covers of the present invention do not need to be constantly replaced. Furthermore, embodiments of the lug nut covers of the present invention provide an enhanced and tighter fit with the lug nut, which not only provides better protection for the lug nut, but prevents the cover from falling off the nut and requiring replacement.

The foregoing descriptions of various embodiments have been presented for purposes of illustration and description. These descriptions are not intended to be exhaustive or to limit the invention to the precise forms disclosed. The embodiments described provide the best illustration of the inventive principles and their practical applications to thereby enable one of ordinary skill in the art to utilize the disclosure in various embodiments and with various modifications as are suited to the particular use contemplated.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

I claim:

1. A cover for protecting a lug nut of a vehicle wheel comprising a body having a circular opening at an end thereof for receiving said lug nut, wherein the opening is sized in order to tightly fit over said lug nut.

2. The lug nut cover of claim 1 wherein said body has a round shape.

3. The lug nut cover of claim 1 wherein said body has a hexagonal shape.

4. The lug nut cover of claim 1 further comprising a threaded bore extending into said body from said opening for threadably receiving a bolt onto which said lug nut has been engaged.

5. The lug nut cover of claim 4 further comprising a circular groove adjacent to said opening, and a rubberized O-ring provided in said groove.

6. The lug nut cover of claim 5 wherein said body is made of metal.

7. A cover for protecting a lug nut of a vehicle wheel comprising a body having a circular opening at an end thereof for receiving said lug nut, and a threaded bore extending into said body from said opening for threadably receiving a bolt onto which said lug nut has been engaged.

8. The lug nut cover of claim 7 wherein said body has a round shape.

9. The lug nut cover of claim 7 wherein said body has a hexagonal shape.

10. The lug nut cover of claim 7 wherein said body has a pentagonal shape.

11. The lug nut cover of claim 7 wherein said body has a octagonal shape.

12. The lug nut cover of claim 7 wherein said body has a square shape.

13. The lug nut cover of claim 7 wherein said body is made of metal.

14. The lug nut cover of claim 7 further comprising a circular groove adjacent to said opening, and a rubberized O-ring provided in said groove.

15. The lug nut cover of claim 14 wherein said body has a round shape.

16. The lug nut cover of claim 14 wherein said body has a hexagonal shape.

17. The lug nut cover of claim 14 wherein said body has a pentagonal shape.

18. The lug nut cover of claim 14 wherein said body has a octagonal shape.

19. The lug nut cover of claim 14 wherein said body has a square shape.

20. The lug nut cover of claim 14 wherein said body is made of metal.
